(19) United States
(12) Patent Application Publication
(10) Pub. No.: US 2005/0133500 A1
(43) Pub. Date: Jun. 23, 2005

(54) Polygonal susceptor cooking trays and kits for microwavable dough products

(76) Inventors: Joseph R. Brooks, Chicago, IL (US); Paul A. Cogley, Chicago, IL (US); Derek J. Romeo, Evanston, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/989,929

(22) Filed: Nov. 16, 2004

Related U.S. Application Data
(63) Continuation-in-part of application No. 10/443,252, filed on May 22, 2003.

(51) Int. Cl. H05B 6/80

(52) U.S. Cl. 219/730

(57) ABSTRACT

A polygonal susceptor tray has a susceptor surface of a platform positioned above a downwardly extending portion that has sidewall functions and that traps heated vapor within an open surface defined by the susceptor tray. A kit of the susceptor tray and a dough-containing food product has a storage mode which permits the food product to be stored within the open volume and out of contact with the susceptor surface. The planar portion of the tray includes openings including both a wide-dimensioned opening and a narrow-dimensioned opening in selected respective areas of the susceptor surface.

### CROSS-REFERENCE TO RELATED APPLICATION

This is a continuation-in-part of application Ser. No. 10/443,252, filed May 22, 2003, incorporated by reference hereinto.

### FIELD OF THE INVENTION

The present invention generally relates to improvements in connection with microwaving of dough-containing food products. More particularly, the invention relates to enhancements within the microwaving context which includes the use of a susceptor tray. The invention is particularly well suited for a dough product having a substantial crust volume having a perimeter which is a polygon, such as a rectangle or square, and which is to be subjected to microwave energy in order to cook or otherwise heat the dough so as to render it palatable and ready for serving and consumption.

### BACKGROUND OF THE INVENTION

Food products which require a minimum amount of consumer preparation and are quick to prepare are common items on grocery store shelves, in refrigerated displays or in freezer cases. Included in these are food products which traditionally are served hot or warm and include a heating step during the course of their preparation for consumption. Included in these types of food products are ones which incorporate a substantial volume of dough or batter which is formed into a product having a crusty surface. Such food products include those which are or have bread or crust components. Products of this general type include hot sandwiches, pocket-type food products, wraps, pizzas, dumplings, pies, breads and rolls.

A substantial problem which must be addressed in preparing successful dough-containing food products such as those of these types arises when dough or batter products are subjected to microwave energy in order to cook and/or heat the food product. Problems in this general area have been recognized in many forums. Included is patent art such as Ottenberg U.S. Pat. No. 4,463,020, Meraj et al. U.S. Pat. No. 4,761,290, Cochran et al. U.S. Pat. No. 4,885,180, Huang et al. U.S. Pat. No. 5,035,904, King et al. U.S. Pat. No. 6,156,356, Paulucci U.S. Pat. No. 6,168,812 and McPherson et al. abandoned U.S. Published Patent Application No. 2002/0064586. Each of these is incorporated hereinto by reference. These references include proposals for formulating the dough or batter in a way that avoids or minimizes various negative impacts which are thought to be caused by the nature of microwave heating.

For centuries, the dough-making art has been based upon placing the dough to be baked or heated within an area providing primarily conduction heating. Generally, this approach cooks or heats through direct surface heating and drying effects of heated air surrounding the food being prepared. Contrary to these often called “conventional” approaches, applying microwave energy energizes polar and ionic molecules tending to result in heat generation. While the heating effects of such microwave energy depend on many factors, including shape, size, thickness and composition of the food product, there tends to be a heating from under the surface, or inside, of the food product out to its surface, while product surface temperatures remain relatively low due to evaporative cooling and low microwave cavity temperatures. In many situations, this heating is much more rapid along edge areas than it is in central areas of food products having somewhat uniform thickness, such as sheet pizzas. In an effort to achieve uniform cooking, unpalatable characteristics such as toughness and a leathery texture often can develop. Sometimes, these negative texture attributes develop in some areas of the food product but not in others.

Contributing to reduced palatability of microwaved dough-containing food products is the difference in drying action when the same dough formulation is subjected to external heat as in a conventional oven when compared with heating achieved by the application of microwave energy to the food product. There is a tendency for less uniform liquid removal when a food product is subjected to microwave energy, especially when comparing same with conventional oven cooking or heating. Microwaved food products can exhibit undesirable soggy texture or leathery overcooked texture, typically in some areas of the food product but not in others. This is especially the case for such food products which are in the shape of a square, rectangle or other polygon, as opposed to a circular food product for example.

This background illustrates problems faced when attempting to formulate dough or batter products that are intended to be cooked, baked or heated within a microwave oven. Some or all of the food product being heated can have a variety of palatability issues, including those caused by having excess moisture within frozen food products, whether it be a dough component or another component such as a topping or filling. Such can result in excess softness and/or sogginess. All or some of the food product can become overexposed to microwave energy, often resulting in a tough or leathery consistency. These microwave issues can include having the crumb or the dough component take on a rubbery and/or gummy consistency. In general, a leathery crust becomes harder to chew and is not easily or pleasantly masticated.

The art, as generally represented by the patent art noted above, has made substantial strides in addressing these types of problems. This includes the dough formulation approaches discussed in each. Art such as Paulucci identified above propose susceptor sheet use. Other art in this general category includes several different variations on susceptor sheeting in an effort to solve this problem. Included are the following, each being incorporated by reference hereinto: Palowski U.S. Pat. No. 4,896,009, Swiontek U.S. Pat. No. 4,960,598, DeRienzo U.S. Pat. No. 5,223,685, Gics U.S. Pat. No. 5,565,228, Young U.S. Pat. No. 5,585,027, Sadek et al. U.S. Pat. No. 6,359,272, Cole et al. U.S. Pat. No. 6,414,290 and U.S. Pat. No. 6,765,182, Aronsson et al. U.S. Pat. No. 6,476,368 and Pedersen U.S. Pat. No. 6,627,862.

Art of this type recognizes that microwave cooking or heating of generally sheet-like food products is believed to be enhanced by providing a microwave susceptor material, such as aluminum, on a surface on which the food product rests. When microwaves strike the microwave susceptor material, higher temperature heating results. This heat generation is believed to be useful in ensuring thorough cooking of the underside of the food product in an effort to address issues such as soggy pizza crusts when microwave heated. For example, U.S. Pat. No. 6,476,368 teaches providing a susceptor panel for heating garnished flat dough in microwave ovens. A plurality of apertures are provided in the susceptor panel for forming gas and microwave energy permeable areas which are taught to be positioned at specific locations on the susceptor panel. U.S. Pat. No. 6,414,290 proposes the use of an imperforate susceptor plate which has a pattern of microwave-transparent areas interspersed within the microwave susceptor surface. This is said to enhance crust browning.

U.S. Pat. No. 5,223,685 shows an elevated microwave cooking platform. The cooking surface of this platform has a series of larger openings intended to provide direct contact between food supported on the platform and air beneath the platform. Support legs elevate the platform and the food thereon so as to provide more room beneath the platform and the food supported on the platform. The support legs are widely spaced apart. Air circulating beneath the platform in between the widely spaced legs evaporates moisture from this air.

Approaches of the art thus far have not fully succeeded in providing microwave heated, cooked or baked dough-containing products that exhibit organoleptic properties and superior palatability for the same type of food product when it is heated, cooked or baked within a conventional oven which applies cooking and drying heat to the outside of the food product. The objective of parity between microwaved food products and the same type of product cooked by conventional oven approaches has not been achieved heretofore. This is especially true for frozen pizzas which are intended to be heated by microwave energy such as that put forth by a household microwave oven.

As a convenience feature, it often can be desirable to provide susceptor devices that are easy to use, inexpensive and disposable and do not substantially add to the bulk of the food product as packaged for distribution. It would be desirable to have a combination or kit which is a self-contained assembly of the food product and of the tools needed to properly heat, cook or bake that very food product within a microwave oven including those designed for household use.

Polygonal food products such as rectangular frozen pizzas for microwave heating can take certain production approaches that are less suitable for food products that are round or have curved edges. There also are production approaches that can be taken for making polygonal-shaped trays which are not available for trays that are circular or otherwise curved.

One production approach that is more suitable for polygonal products relates to the food product itself. Square or rectangular-shaped dough or crust products are able to be formed by a so-called sheeting approach. Large sheets of dough are made up on commercial baking lines and are severed horizontally and vertically in order to form a properly sized dough sheet without dough waste which would be experienced with a product that is circular, for example. Such a die cutting approach provides another option besides another often-used approach that is more suitable than the sheeting approach to make round bakery products. This other approach in one in which a dough ball is pressed into shape, such as a circular one, which then can be trimmed with a die if needed. Thus, there can be a production advantage to preparing a dough product that has a polygonal perimeter when it is be cut from a large sheet.

Another production benefit of polygonal dough products to be microwaved relates to the shape of susceptor trays which can be used to heat polygonal dough products in the microwave oven. Susceptor trays of the type discussed herein have a sidewall depth which defines an open volume. Such structures can be made by two basic approaches. One is to form an essentially flat sheet of paperboard and re-form it by molding into a configuration such as that of a pie tin or pan. This can be referred to as pressed board technology. An alternative is to have a susceptor tray made by die-cut technology. By this approach, a flat sheet of paperboard or the like is cut and folded and assembled into a pan type of configuration. This die-cut technology is not suitable for trays having circular shapes or shapes having curved perimeter portions. Reliable cutting, folding and assembling requires planar sidewalls which can be readily folded along substantially straight lines and assembled to adjoining folded planar sidewalls. This provides an incentive for providing microwave susceptor trays with a polygonal perimeter.

However, providing these kinds of opportunities for production alternatives and their possible advantages leads to disadvantages. Included is the difficulty of evenly cooking dough products through microwave techniques when such dough products have areas that are spaced farther from a center point than are other areas. A square pizza dough is an example; the corners of the square are farther from the center than the rest of the areas of the square perimeter. Most microwave ovens provide a more uniform cook to a perimeter, such as a circumference, that is equidistant from a center point than one that is not, such as a polygon, for example a square. Accordingly, a polygonal product that is to be microwaved creates a problem of how to avoid unevenness of cooking.

Thus, for microwavable dough products, an important advance would be to have a polygonal product and complementary susceptor tray which can realize the production benefits discussed herein by addressing the difficulties of microwave cooking of such a polygonal product.

Referring specifically to a product which is particularly difficult to properly prepare, it is generally appreciated that thin crispy crust pizzas are difficult to cook in a microwave oven. A particular problem is present for polygonal, such a rectangular, pizzas, which, when microwaved, typically leave the crust uncrisp in the center and chewy on the corners. The invention addresses such problems by combining openings of different types within the susceptor area in order to optimally brown and crisp the crust. A particular problem is that square corners typically are overcooked in microwave cooking which satisfactorily cooks the rest of the pizza. A solution provided by the invention thoroughly crisps and browns the center without overcooking the corners of the pizza.

Providing susceptors made of pressed board with a laminated susceptor creates issues. The present invention allows the substitution of the pressed board technology with a die-cutting technology to prepare the susceptor tray, which enables the susceptor material to be laminated to flat stock, such as paperboard. Such a die-cut design incorporates tabs, flaps or other mechanisms that enable it to be erected mechanically at the production facility.

### SUMMARY OF THE INVENTION

In accordance with the present invention, a polygonal-shaped microwave susceptor tray is provided which has a susceptor heating surface that is sized and shaped to accommodate a dough-containing food product during a heating mode. The invention is especially useful when the food product is of a polygonal shape. The susceptor surface includes openings therethrough which are tailored in position and size to achieve uniform microwave cooking of the dough product. The susceptor tray further includes an extending portion that cooperates with other surfaces of the susceptor tray to define a tray volume. This tray volume has at least two purposes, one during a packaged, pre-cooking mode and another during a cooking mode. In the former, the tray volume provides a compact packaging, distribution and storage space for the dough-containing food product when the food product and polygonal tray are packaged as a unitary consumer-purchasable product. During the cooking mode, this tray volume of the susceptor tray functions to hold a source of moist heated air directly beneath the food product being cooked or heated, thereby facilitating the advantageous microwave cooking effect of the invention.

In an aspect of the invention, the susceptor tray is provided such that a polygonal dough-containing food product is readily stored within its defined inside volume while, when unpackaged, providing a polygonal platform for spacing the food product above the floor of the microwave oven in order to facilitate product heating, cooking or baking.

In a preferred aspect of the invention, one or more of the features discussed herein are combined with one or more openings that allow for material that is driven off from the food product during cooking to pass into the susceptor tray volume and be held there for a desired period of time and to allow cooking action though the openings in order to thereby impart uniform cooking of the food product during exposure to microwave energy.

In a further aspect of the invention which can, if desired, be used in combination with the other features disclosed herein, the susceptor tray can be made according to die-cut technology in order to provide a susceptor tray which is rectangular or of other polygonal shape.

It is a general object of the present invention to provide improved packaged microwaveable dough-containing food products which can have a polygonal periphery. Another general object of the invention is to provide a microwave susceptor tray that can have a polygonal periphery and functions both as a packaging element and as a cooking platform which provides an underside volume that enhances heating when a food product is positioned on the platform and subjected to microwave energy. Another general object of the invention, which can be combined with other features of the invention, is to provide a microwave dough-containing food product kit which includes the food product packaged within the susceptor tray.

In an important aspect of this invention, the features of the invention enhance the value of convenience food products, especially thin crispy crust pizzas, which are designed to be cooked, baked or heated by microwave energy. A primary aspect of this enhancement is that the thus prepared food item has a crisp and brown crust throughout the center and maintains good quality corners. The prepared food item preferably has organoleptic and palatability characteristics which are not statistically distinguishable from like food products that are cooked, baked or heated by conventional heat-generating ovens such as those using convection principles.

These and other aspects, objects, features and advantages of the present invention, including the various features used in various combinations, will be apparent from and clearly understood through a consideration of the following detailed description.

### BRIEF DESCRIPTION OF THE DRAWINGS

In the course of this description, reference will be made to the attached drawings, wherein:

FIG. 1 is an exploded perspective view showing an embodiment of the invention which incorporates an overwrap member in combination with a square tray and packaged food product positioned within its interior volume;

FIG. 2 is a cross-sectional view showing the susceptor tray and the food product of FIG. 1 in their combined cooking mode and as oriented within a microwave oven;

FIG. 3 is an enlarged cross-sectional view through and end portion of FIG. 2;

FIG. 4 is a top plan view of a blank for an embodiment of a susceptor tray according to the invention, prior to assembly;

FIG. 5 is a perspective view of a susceptor tray of a type assembled from a blank of a type illustrated in FIG. 4;

FIG. 6 is a plan view of another embodiment of a susceptor tray according to the invention, prior to assembly;

FIG. 7 is a plan view of a further embodiment of the susceptor tray according to the invention, prior to assembly;

FIG. 8 is a top plan view of an additional embodiment of a susceptor tray according to the invention, prior to assembly;

FIG. 9 is a top plan view of an additional embodiment of a susceptor tray according to the invention, prior to assembly;

FIG. 10 is a perspective view of yet a further embodiment of a susceptor tray according to the invention;

FIG. 11 is a top plan view of the embodiment of FIG. 10;

FIG. 12 is a perspective view of yet an additional embodiment of a susceptor tray according to the invention;

FIG. 13 is a top plan view of the embodiment of FIG. 12;

FIG. 14 is a perspective view of a further embodiment of a polygonal susceptor tray oriented for receiving a food product for packaging; and

FIG. 15 is a top plan view of the embodiment of FIG. 14;

FIG. 16 is a cross-sectional view along the line 16-16 of FIG. 15;

FIG. 17 is a perspective view of an additional embodiment of a polygonal susceptor tray oriented for receiving a food product for packaging;

FIG. 18 is an elevational view of the susceptor tray of FIG. 17; and

FIG. 19 is a cross-sectional view along the line 19-19 of FIG. 18.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

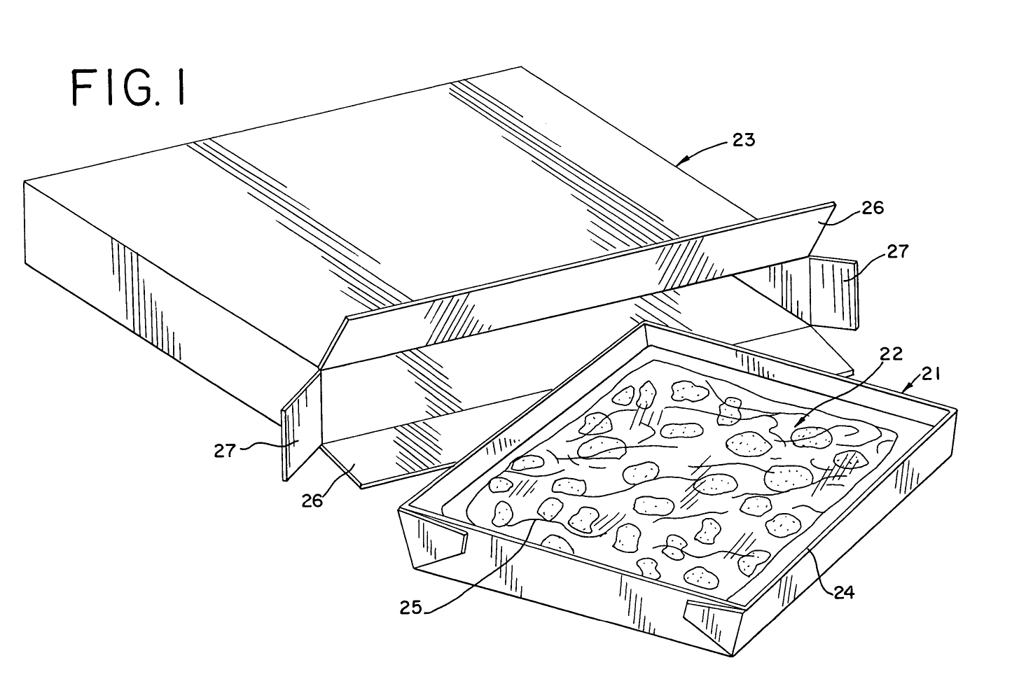

FIG. 1 illustrates an embodiment of the invention which includes three principal components. A microwave susceptor tray is generally designated as 21. A dough-containing food product is generally designated as 22. An example of secondary packaging is generally designated as 23. It will be noted that the food product 22 fits within and is accommodated by the tray 21. Inasmuch as these products are to be sold commercially, secondary packaging typically would be included so as to provide adequate surface area for required labeling, for product identification, manufacturer information, and marketing information, for example. Secondary packaging also provides additional barrier protection for the food product, as well as tamper evidence protection.

Suitable secondary packaging can take the form of a somewhat rigid carton or box as generally shown in FIG. 1. Such a carton 23 is made of paperboard, optionally treated as desired for protection, such as enhanced light and moisture barrier properties or other reasons for external boxing, including product protection, reduced oxygen transmission and the like. Treatment can include one or more polymer layers. The secondary packaging can be for single or multiple products.

When it is deemed that, in appropriate commercial settings, boxing of individual or multiple products is neither desired nor required, other secondary packaging members can be used. This includes a flexible wrapping which totally encloses the susceptor tray 21, or multiple susceptor trays 21. Closely conforming secondary packaging could thus be used. The secondary packaging also could take the form of an envelope which encloses the susceptor tray 21. A further approach could be the use of sheeting which engages a peripheral edge 24 of the susceptor tray, thereby sealing the dough-containing food product 22 within the susceptor tray 21. It will be appreciated that other approaches can be devised for performing the secondary packaging or functions noted above.

The version of the invention which is shown in FIG. 1 further includes a protective wrapping 25 for the dough-containing food product itself. Such protective wrappings are well-known in the art. They are useful in maintaining the integrity of the dough-containing food product, which may include garnishes, toppings or the like which could be damaged or separated from the food product during normal handling. A protective wrapping 25 also can serve the purpose of providing a convenient location for cooking, baking or heating instructions, as well as provide product identification and labeling functions to the extent these functions would not be already provided by any secondary packaging, particularly in those situations where secondary packaging is not required or used.

It will be appreciated that, with the embodiment shown in FIG. 1, the consumer or food preparer will purchase the product with the dough-containing food product within the otherwise open volume of the susceptor tray. In this way, the susceptor tray provides good protection for the dough-containing food product. Ideally, the entirety of the dough-containing food product (or a major portion of the entire food product) lies below, or at least no higher than, the peripheral edge 24 of the susceptor tray. This susceptor tray and dough-containing food product combination is accommodated by the secondary packaging when provided, such as the illustrated carton 23. In the case of the illustrated carton 23, its end flaps 26, 27 are closed and sealed so that the susceptor tray and food product are totally within the carton. With this illustrated embodiment, this is the form in which the consumer or food preparer will purchase the product. When this is a frozen product, this packaged product will be stored in an appropriate freezer case. Refrigerated or shelf stable products would be stored and/or displayed in suitable merchandizing equipment or shelving.

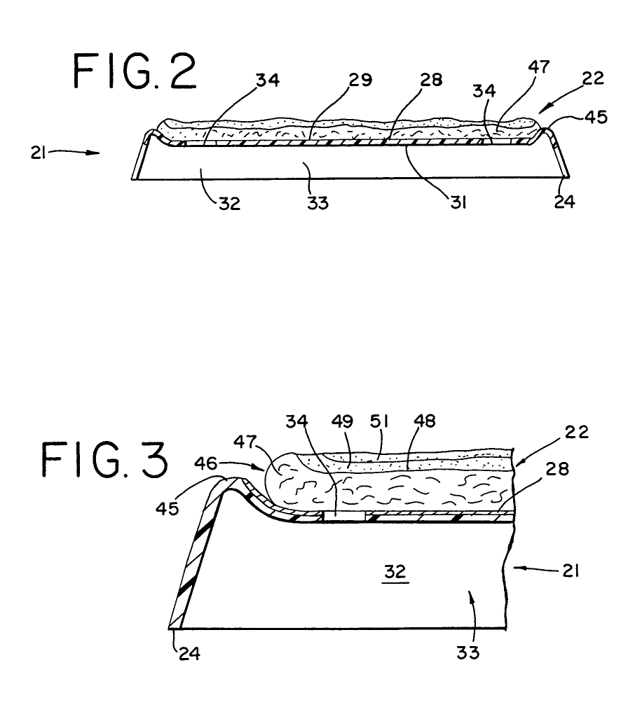

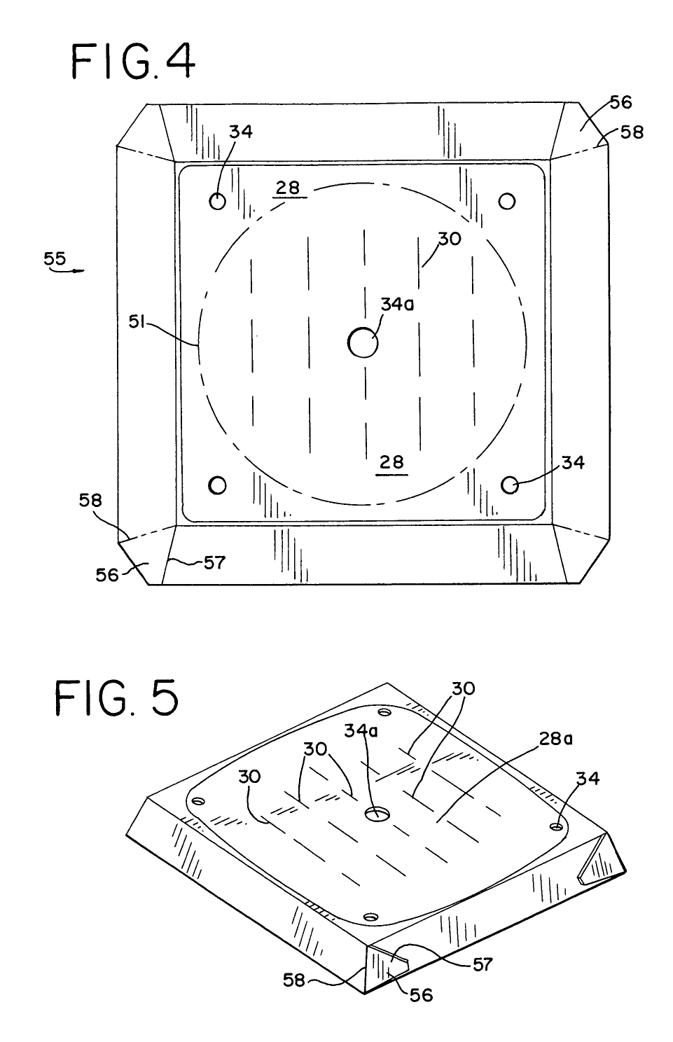

Microwave susceptor tray 21 includes a susceptor surface 28, as seen for example in FIG. 2, FIG. 3 and FIG. 4. An alternate susceptor 28a is shown in FIG. 5, such being especially suitable for a food product having a curved periphery. It is important to note that this susceptor surface is on an outwardly facing face 29 of the generally planar portion of the susceptor tray. It will be appreciated that the terms generally planar or planar can encompass surfaces having depressions, raised portions, texture, holes, perforations and the like, and is not intended to mean planar in a strict geometric sense. As is generally known, susceptor material contributes to browning of dough products such as pizza crusts. The susceptor material causes localized heating which develops temperatures that are more elevated than other non-susceptor areas. Such elevated temperatures promote Maillard reactions in the crust or other dough material where contact occurs between same and the susceptor material. This effect is less likely to be observed in areas without direct contact of this type, such as at openings where no susceptor material is present.

The opposite face of this generally planar portion is an inwardly facing face 31. This face 31, together with an extending portion or component 32, define the volume 33 of the microwave susceptor tray 21. This tray volume preferably is adequate to accommodate the dough-containing food product 22 when in the packaged, non-cooking mode, as generally discussed above. The tray volume also functions to enhance cooking and/or moisture retention, and often also cooking uniformity, at times in cooperation with porosity which can be provided in the downwardly depending extending portion or sidewall 32.

The extent and confining nature of the volume 33 play an important role in enhanced microwave heating performance achieved by the invention. Important to such performance is the combination of the size of this confined tray volume with its location under the microwave cooking surface provided by the susceptor surface 28 of the outside facing face 29 of the generally planar portion or component of the microwave susceptor tray. The importance of this combination is discussed in greater detail elsewhere herein.

With further reference to the generally planar portion of the microwave susceptor tray 21, a plurality of openings are included which provide locations of access between the outwardly facing face 29 and the tray volume location 33. The openings thus provide means for passing byproduct material from the baking, cooking or heating of the dough-containing food product through the generally planar tray portion and into the tray volume location 33. Materials which are especially important in this regard are vapors which are given off by the food product during heating. For example, the openings facilitate dissipation of water vapor generated during baking, heating or cooking, especially of a frozen food product, which could otherwise lead to development of a soggy bottom surface of the food product.

Furthermore, materials, especially steam, driven off from the food product which pass through the openings help to provide a medium for enhanced heating or cooking action within the confined volume below the susceptor surface. In essence, vapors or other food byproduct materials provide a heated medium within the susceptor tray volume. That heated medium provides a warm air or a convection heating which approximates the type of heating action provided by a non-microwave, conventional oven. It also provides a “steam effect” that further heats the bottom of the crust to give it a crispy bottom texture and an even, brown color. This steam is preferably controlled to keep the proper amount of moisture in the food product in order to prevent the crust from becoming too hot and dehydrated, resulting in an overcooked crust that can become too hard, tough and chewy.

This steam effect assists in heating, baking, or cooking the food product while providing an additional, moist heat source from below the food product, thereby cooperating with the microwave energy heating in order to provide enhanced heating action according to the invention, which results in food products having palatability and organoleptic properties which mimic those of like food products which are cooked, baked or heated within a conventional, non-microwave oven.

With further references to the openings, two types are shown. One type is a relatively wide-dimensioned opening 34, and the other is a narrow-dimensioned opening 30. In many embodiments there are a plurality of each such type of opening 30, 34. The location of the openings typically includes the following. A wide-dimensioned opening 34a (FIG. 4) can be included in the approximate center of the susceptor surface. A typical such central opening has a width or diameter of between about 0.25 inch and about 0.75 inch, preferably between about 0.375 inch and about 0.675 inch (about 0.6 cm to about 1.9 cm, preferably about 0.9 cm to about 1.6 cm).

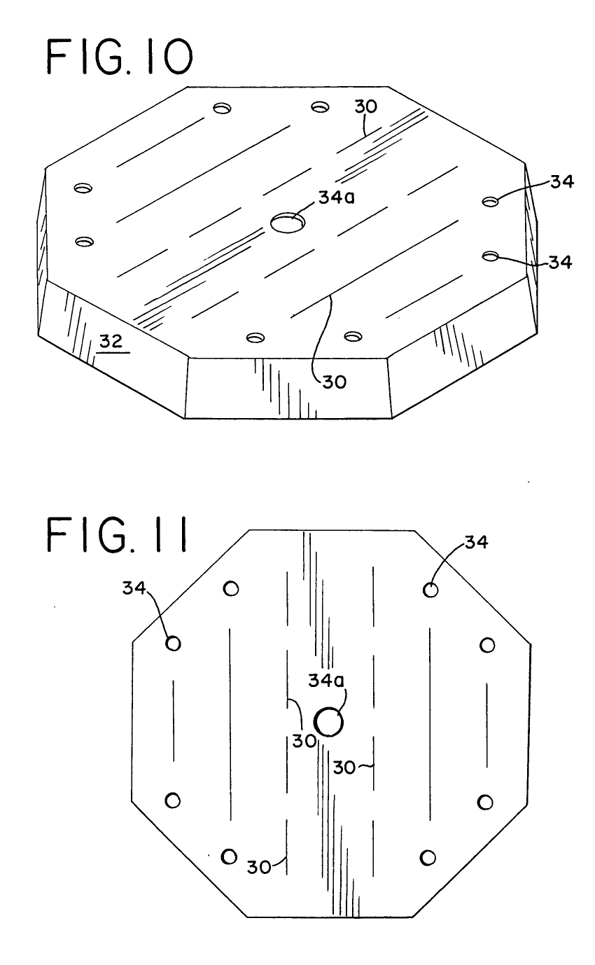

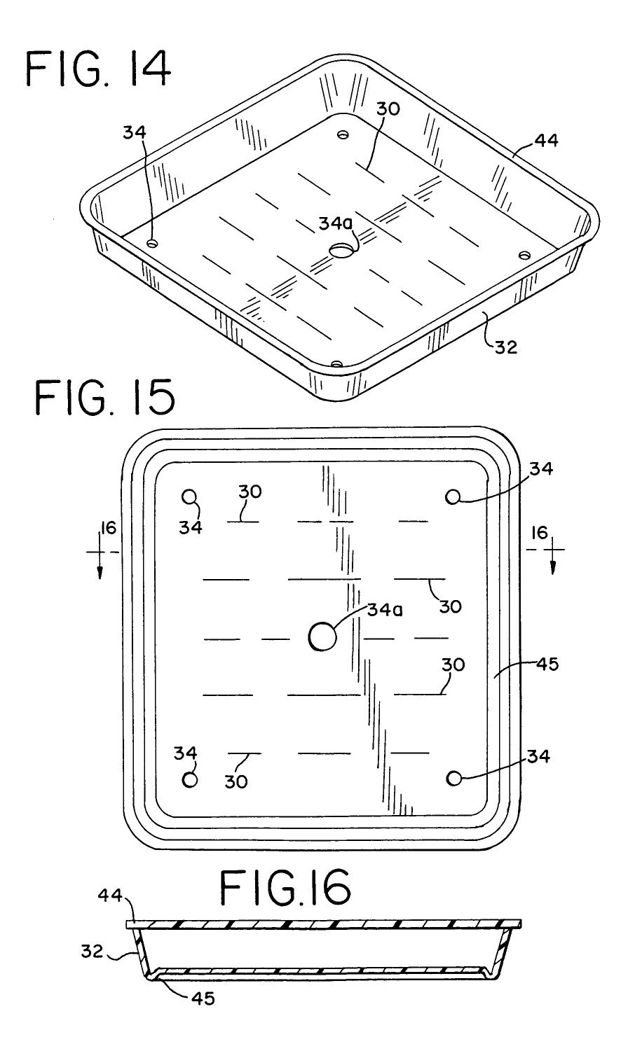

In the preferred embodiment for these openings, at least one relatively wide-dimensioned opening 34 is positioned in each corner area of the susceptor surface. One such opening is shown in each corner of FIG. 4, FIG. 5, FIG. 7, FIG. 8, FIG. 10 and FIG. 11, FIG. 14 and FIG. 15, while two such openings are shown in each corner of FIG. 15. When such openings are provided, typical widths or diameters are between about 0.125 inch and about 0.5 inch, preferably between about 0.2 inch and about 0.35 inch (about 0.3 cm and about 1.30 cm, preferably between about 0.5 cm and about 0.9 cm). The corner area positioning for these openings is for addressing problems of microwaving which are experienced at corner areas of polygonal shaped dough food products, typically characterized as overcooking leading to toughness and leathery organoleptic qualities. Such configurations of the openings have been found to provide an optimum combination of reduced susceptor material and controlled passage of gasses through the susceptor surface in order to achieve uniform cooking at the corner areas under conditions which carry out uniform cooking of the central areas as well.

Narrow-dimensional openings 30 are generally concentrated in somewhat intermediate areas of the susceptor surface. This is illustrated in the preferred embodiment such as illustrated in FIG. 4 where a plurality of narrow-dimensioned openings 30 are located between a central opening 34a and corner-area openings 34. These narrow-dimensioned openings 30 are in the nature of slits and have virtually no, or minimal, width. Also pin holes are a special case of slits, also having no, or minimal length. Typically, openings 30 are made with a fine blade or punch and remove virtually no material when formed. As such, the openings 30 allow gas passage, typically limited in flow volume, through the susceptor surface without significantly reducing the susceptor surface at the location of each opening 30. Multiple slits are positioned in patterns which preferably provide roughly consistent gas and heat passage in such intermediate susceptor locations. This is illustrated in FIG. 4 for its intermediate area 51. Similar intermediate areas are illustrated in other Figures.

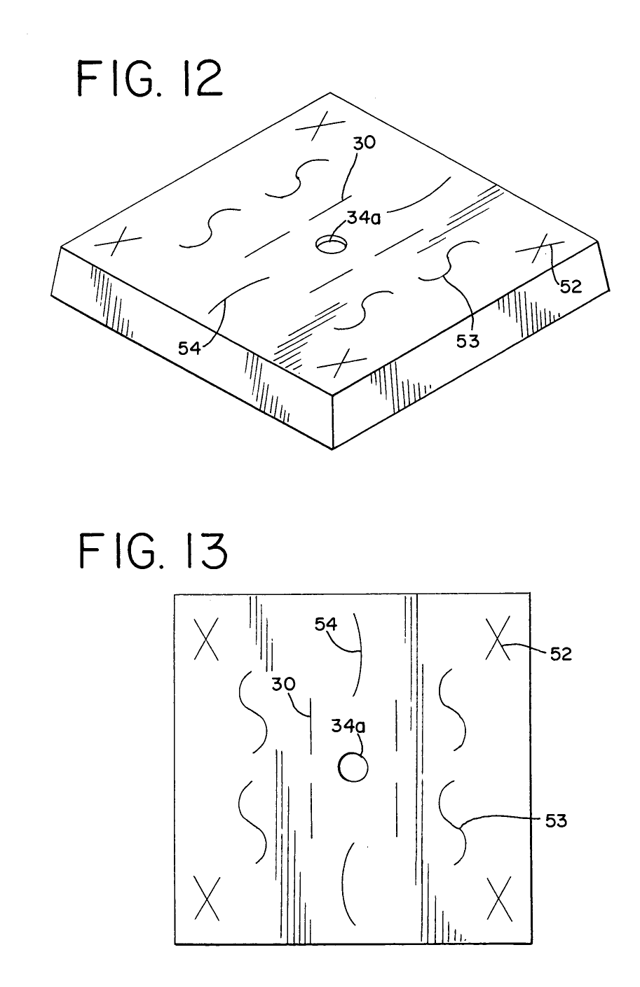

It will be noted that the openings can be straight, curved, of a point-like configuration or be openings of regular symmetrical shapes such as circles, squares or triangles. FIGS. 12 and 13 illustrate that the openings can take the form of indicia of recognizable shapes such as letters 52, 53 of the alphabet, arcs 54, numbers and the like. In this embodiment, intersecting lines take the place of relatively wide-dimensioned openings 34. The length, number, size and placement of openings 30 and 34 can vary depending on the size and shape of the food product.

Referring further to the openings provided in the susceptor tray surface, it is generally preferred that such openings be approximately evenly spaced along the intermediate portion of the susceptor surface. Usually these are narrow-dimensioned openings. Preferably, adequate spacing is provided between adjacent openings to minimize weakening of the structural integrity of the tray. For example, when the narrow openings are slits, they are spaced longitudinally from each other and form an alternating or perforated appearance. They are, of course, also spaced laterally apart as evident from the Figures. It has been found that by thus maintaining the strength and structural integrity of the tray, the tray surface is better able to provide and maintain a flat, planar susceptor surface during production, storage and use. Such a flat, planar susceptor surface enhances cooking consistency by providing a surface that provides predictable interaction with the dough of the product resting on it during microwave cooking.

It will be appreciated that the relatively wide-dimensioned openings 34 represent the absence of susceptor material and the attendant reduction in heating which is attributable to microwave energy impingement upon the susceptor material. Generally speaking, where susceptor material is not present, the browning effects of the microwave energy are reduced in intensity. Relatively small sized and relatively evenly spaced openings help to ensure that there will be minimal development of noticeable light-colored areas on the bottom of the food product crust.

The size and spacing of the passages through the generally planar panel of the susceptor tray can be quantified as a venting ratio. For the relatively wide-dimensioned openings, the openings can take up a total of between about 0.2 square inch to about 0.6 square inch, preferably between about 0.25 and about 0.55 square inch for every approximately 50 square inches of the susceptor material cooking surface (between about 1.3 square centimeters and about 3.9 square centimeters, preferably between about 1.6 square centimeters and about 3.2 square centimeters, for every approximately 320 square centimeters of susceptor surface). For the narrow-dimensioned openings, the total liner extent is between about 8 inches and about 18 inches, preferably between about 10 inches and about 16 inches for every approximately 50 square inches of the susceptor material cooking surface (between about 29 centimeters and about 46 centimeters, preferably between about 25 and about 41 centimeters for every approximately 320 square centimeters of susceptor surface). Typically, the openings will comprise between about 0.4 percent and about 1.6 percent of the susceptor material cooking surface.

The correct elevation and the surface area of the susceptor tray make up the volume underneath the susceptor planar surface, which is coupled with the correct number and size of openings and/or apertures to allow the needed amount of moisture or steam to leave the dough yet not dry it out. To control the right amount of steam trapped beneath tray, side vent apertures may be added to include outside venting of steam. By providing side vent perforations, consumers can customize the susceptor tray to their preference or to improve cooking in a particular microwave oven.

More particularly, the extent of supplemental heating from below can be varied or tailored according to the make-up of the extending portion 32 of the microwave susceptor tray. In one embodiment, the extending portion can be imperforate and have no passages therethrough. One or more perforated areas 35 can be positioned around the extending portion 32a, as illustrated in FIG. 9. The consumer then has the ability to easily adjust the heat applied by the vapors and other materials which might be present and which are heated within this tray volume. By removing one or more parts of the extending portion which are defined by the perforated areas 35, the consumer provides a passage for such heated vapors out of the susceptor tray volume. Generally speaking, the greater the number of perforated areas which are opened by the consumer, the less heat will develop and remain within the susceptor tray internal volume, and the less will be the heating afforded by the from-below heat source which is provided in accordance with the invention. It is currently believed that having an extending portion with apertures is not required or preferred for good microwave cooking results for at least thin, crispy crust pizza products.

In the alternative embodiment which is illustrated in FIG. 9, the susceptor tray, as manufactured has pre-selected porosity of the extending portion 32a. A plurality of apertures 36 are positioned on the extending portion 32a. This provides an as-manufactured porosity deemed to be suitable for the particular food product and for a typical household microwave oven. Supplying the perforated areas 35 allows the consumer to account for any differences in the operation of individual microwave ovens and for consumer taste preferences. For example, if a particular microwave oven heats more efficiently than the norm, creating more sidewall porosity by removing one or more perforated areas 35 will offset somewhat the supplemental heating achieved by the susceptor internal volume heat sink within that oven. Similarly, if a consumer cooking preferences warrant, increasing the side porosity by removing one or more perforated areas 35 will provide a reduced steam effect.

As illustrated in FIG. 9, both apertures 36 and perforated areas 35 can be provided in the extending portion or sidewall of the microwave susceptor tray. This provides a minimum porosity level when manufactured, while still affording the consumer the ability to increase the porosity for reasons generally outlined above. The manner by which porosity is provided and/or varied is not limited to circular openings or apertures or perforations as specifically shown in the drawings, although the circular shape tends to have advantages of efficiency in manufacturing and ease of removal by the consumer.

Additionally, the precise shape of the extending portion 32, 32a which is shown in the drawings can be varied as desired. While the extension portion should be easy and inexpensive to manufacture, it can be varied as desired. It is important that the extending portion provide the function of elevating the susceptor surface above the floor of the microwave oven, combined with the function of providing a substantial barrier to the escape of vapor and other byproduct material from heating the food product so that same will remain within the susceptor tray volume 33 for a length of time that significantly enhances the heating, cooking or baking function as described herein. Often, for ease of handling and stacking of susceptor trays in the food processing and production plant, the extending portion is wider on the open end of the tray than on the closed end where the susceptor surface is located. For example, this allows for nesting of trays when stacked.

Variations in the extending portion porosity features also are possible. Porosity can vary from as much as 60 percent to zero, as defined by the percentage of open area in the extending portion provided by any apertures in the extending portion. For some applications zero is preferable. For other uses, porosity can be as high as about 50%. In other uses, porosity is as high as about 30%. For still other uses, the porosity can be as great as 25%; for others only as great as 15%; and for others only as great as 10%. In various instances, when extending portion porosity is to be added, it is can be beneficial to have sidewall porosity in the lower portion of the porosity range in order to trap heat more effectively. Typically, sidewall porosity increases cook time, which often is not a desirable attribute. Having the sidewall porosity in the higher portion of the range is usually beneficial when longer cook times are desired for a particular type of product or to address consumer taste preferences.

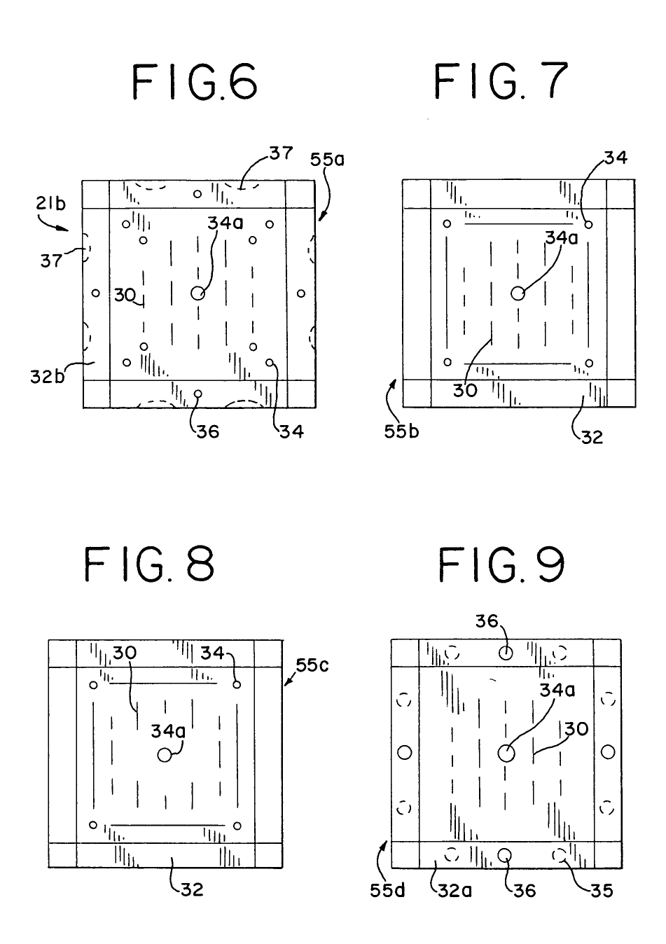

FIG. 6 shows a susceptor tray 21b which has its porosity concentrated near the outside edge or bottom of its extending portion 32b. It is perforated to allow forming apertures 37 which are at or very close to the floor of the microwave oven, when the susceptor tray is in use heating the food product. This arrangement has the benefits, including added strength, of maintaining a substantially imperforate peripheral sidewall portion.

Typically, the susceptor trays will be made of paperboard material, with the exception of the susceptor surface itself. It is possible that more of the outside surface of the paperboard than the generally planar area can be coated with susceptor material. For example, it can be possible to manufacture a tray made of paperboard which is substantially completely covered with susceptor material, on one or both sides or surfaces thereof.

Usually, the shape of the susceptor tray platforms or planar tray portions should correspond to, or be complementary with, the shape of the food product being heated, cooked or baked. Exemplary shapes include squares, rectangles, triangles, octagons, and other polygons. Such polygonal shapes are especially suitable to be made from a flat blank which is die cut, folded and assembled. This is illustrated by blank 55 of FIG. 4 and by blanks 55a, 55b, 55c and 55d of FIGS. 6, 7, 8 and 9, respectively. FIG. 4 shows flap areas 56 being defined in part by a sever line 57 and a fold line 58. FIG. 5 shows assembly with flaps 56 on outside; however assembly can have the flaps inside the tray.

Generally, this die-cut construction approach allows for more design variation for polygonal units than an alternative susceptor tray construction which involves pressing the tray shape from a flat piece of polymer-coated paperboard in order to define the overall shape of the susceptor tray. FIGS. 14, 15 and 16 illustrate a tray made by this type of pressed construction. With either construction technique, aperture, opening, slit, severance and perforation formation are carried out in accordance with the principals known or to be known in the art.

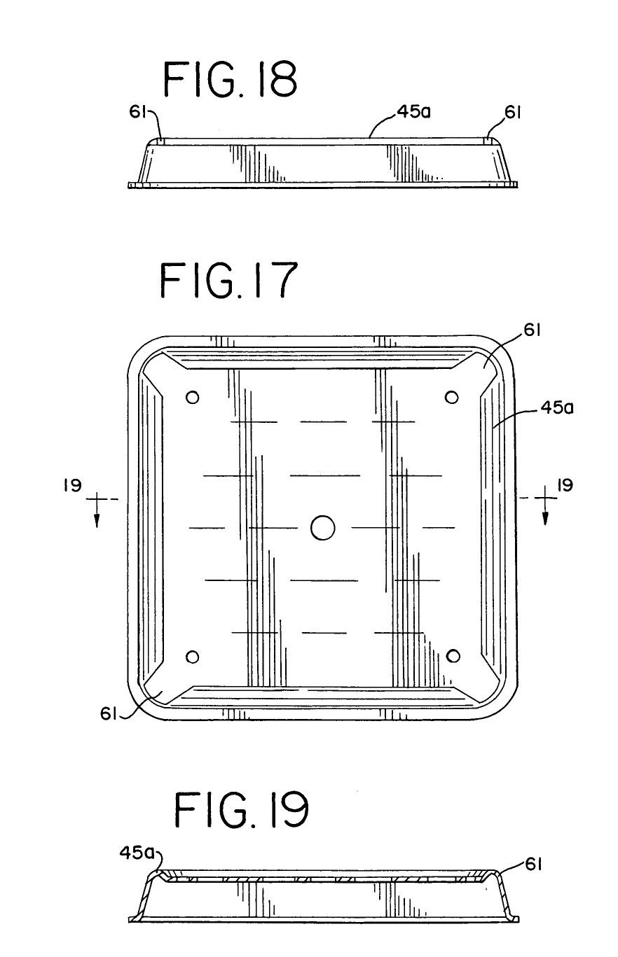

FIGS. 17, 18 and 19 illustrate another tray made by a pressed construction approach. This indicates a manner of modifying the material to be pressed so as to be more suitable for polygonal trays, particularly those having raised bosses. Corner relief is provided in each of the four corners of this rectangular-shaped tray. A raised perimeter boss 45a is positioned along the perimeter of the face which is sized and shaped to receive the food product during the cooking mode. In each corner of the perimeter boss 45a, there is provided a gap 61 which in effect relieves the corners of the boss. This is done in order to avoid a phenomenon known generally as tenting or buckling of the material during the pressing operation. The tray is formed without interference from overlapping areas in the corners, and a clean corner is formed at the gaps 61 as the material is pressed and formed to a configuration such as that shown in FIG. 17.

It will be appreciated that the size of the volume delineated by the tray when in use within a microwave oven will depend upon the dimensions of the susceptor tray. To a large degree, this volume depends upon the area of the periphery or footprint of the generally planar portion and the height of the planar portion from the floor of the microwave oven. The larger the product of this area dimension times this height dimension, the greater will be tray volume. The tray volume substantially defines the boundaries for the vapor that can be accommodated by the susceptor tray. The extent that the maximum calculated volume truly constrains the vapor will depend in part upon the porosity features of the susceptor tray, if present, as discussed elsewhere herein.

For most food products and susceptor trays, the height measurement will be between about 0.5 inch and about 2 inches (about 1.3 cm and about 5.1 cm), preferably between about 0.8 inch and about 1.2 inch (about 2 cm and about 3 cm). When the dough-containing food product 22 is a thin-to-medium crust pizza, its thickness ranges between about 0.25 inch and about 0.5 inch (between about 6 mm and about 13 mm). This illustrates how the tray volume can accommodate a typical food product in the packaged, non-cooking mode. In the case of a polygonal susceptor tray of the type illustrated in the drawings which is sized to accommodate a like-shaped moderately sized frozen pizza, a preferred height ranges between about 0.75 inch and about 1 inch (between about 19 mm and about 25 mm).

The susceptor tray optionally can include material which extends beyond the peripheral edge 24. This can take the form of a peripheral rim 44 (FIG. 14). When provided, rim 44 functions to provide extra material in order to strengthen the extending portion of the susceptor tray, particularly if same is otherwise weakened by apertures 36 or other means to increase porosity and flow through the extending portion 32. Peripheral rim 44 typically will be generally parallel to the generally planar portion having the susceptor surface 28. As such, peripheral rim 44 can enhance the functional stability of the susceptor tray to minimize the chance of unwanted susceptor tray movement during microwaving.

In the embodiment illustrated for example in FIGS. 2, 3 and 16, a raised perimeter boss 45 is at the interface between the generally planar or horizontal portion and the generally downwardly extending portion of the susceptor tray. Raised perimeter boss 45, when provided, helps to maintain the position of the dough-containing food product on the susceptor tray. Preferably, the entire bottom surface of the food product remains in contact with the susceptor material throughout the heating, cooking or baking time, except for where the openings are provided.

FIGS. 1, 2 and 3 illustrate dough-containing food products which take the form of a thin crust square pizza, generally designated as 46. Included is a dough layer or crust 47. The illustrated crust has a central area 48 which extends throughout the crust except for at its periphery. Typically, one or more toppings fill this area. In the illustrated embodiment, a sauce topping 49 has a second topping, such as of cheese material, on its surface. Other toppings can be added as desired. Any of these toppings can be varied as desired in order to suit particular tastes. Subjecting the food product to microwave energy while supported by the microwave susceptor tray according to the invention results in heating, cooking or baking the crust, whether frozen, refrigerated or at room temperature and whether unbaked, partially baked or substantially fully baked. Simultaneously, the topping or toppings are heated until the desired degree of cook is achieved.

The following Examples illustrate certain features and advantages of the invention in order to further illustrate the invention. The Examples are not to be considered limiting or otherwise restrictive of the invention.

### EXAMPLE 1

A plurality of pizzas were prepared. Each had a crust made of a flour composition having the same formulation. Each pizza had the same topping of a tomato-based sauce, which itself had cheese topping thereover. Each cheese pizza was cooked at the same elevation, namely one inch (2.54 cm) above the floor of the microwave oven. Other than differences in the openings though the susceptor surface of the respective cooking trays, susceptors and conditions were the same for each test. Each pizza was microwaved for 3 minutes and 25 seconds in a 1100 watt microwave oven. Each was visually inspected and tested for firmness and crispness after removal from the microwave oven.

A susceptor surface opening configuration as shown in FIG. 4 and with no apertures in the extending portion or sidewall was judged to provide the best uniform cooking without leathery corners or sogginess of the crust. The other susceptor trays tested had different opening configurations that modified venting to and from the pizza. These other tested trays had less or more total opening length and/or opening area and/or included multiple apertures in the extending portions or sidewalls. In addition, the susceptor configuration of FIG. 4 achieved its good results in the shorter cook time.

It will be understood that the embodiments of the present invention which have been described are illustrative of some of the applications of the principles of the present invention. Numerous modifications may be made by those skilled in the art without departing from the true spirit and scope of the invention. Various features which are described herein can be used in any combination and are not limited to precise combinations which are specifically outlined herein.

1. A packaged microwave pizza kit, comprising:
a susceptor tray, said tray having a generally planar portion with a polygonal-shaped perimeter, an inwardly facing face and an outwardly facing face;
a polygonal-shaped susceptor surface on said outwardly facing face of the susceptor tray;
openings through said generally planar portion of the susceptor tray, said openings including at least one relatively wide-dimensioned opening from which material of susceptor tray and surface had been removed and at least one narrow-dimensioned opening;
an extending portion of said susceptor tray which projects generally away from said inwardly facing face and in a direction generally opposite to the direction that the susceptor surface faces;
said extending portion and said inwardly facing face generally define a tray volume location;
a dough-containing food product having a polygonal-shaped perimeter adapted to reside within said tray volume location during a packaged, pre-cooking mode of the kit, said dough-containing food product being further adapted to rest upon said outwardly facing face having said susceptor surface during a cooking mode which includes heating of the dough-containing food product by a microwave oven; and
said openings are adapted to facilitate passage of heat-generating byproduct including vapor from the dough-containing food product.

2. The kit in accordance with claim 1, wherein said polygonal-shaped susceptor surface has a plurality of corner areas and each corner area includes at least one of said wide-dimensioned openings, and said wide dimensioned openings are selected from regular-shaped openings, polygonal openings, indicia-shaped openings, letter-shaped openings, number-shaped openings, and combinations thereof.

3. The kit in accordance with claim 1, wherein said polygonal-shaped susceptor surface has a plurality of corner areas, a central area and an intermediate area, and wherein a plurality of said narrow-dimensioned openings are within said intermediate area.

4. The kit in accordance with claim 1, wherein said polygonal-shaped susceptor surface has a plurality of corner areas, a central area and an intermediate area, and wherein a plurality of said narrow-dimensioned openings are within said intermediate area, and wherein each corner area includes at least one of said wide-dimensioned openings.

5. The kit in accordance with claim 1, wherein said narrow-dimensioned opening is a slit.

6. The kit in accordance with claim 4, wherein said intermediate area has no wide-dimensioned opening, and wherein said narrow-dimensioned openings are slits.

7. The kit in accordance with claim 6, wherein said slits are spaced from each other both longitudinally and laterally.

8. The kit in accordance with claim 5, wherein a plurality of slits are included and are selected from straight-line slits, curved slits, intersecting slits, number-shaped slits, letter-shaped slits, indicia-shaped slits, slits spaced end-to-end from each other and pin hole slits.

9. The kit in accordance with claim 5, wherein a plurality of said slits are provided, and each said slit is spaced from the other slits by a distance which maintains planar flatness to the susceptor surface in order to thereby provide consistent contact between the food product and the susceptor surface beneath the food product during use within a microwave oven.

10. The kit in accordance with claim 1, wherein said susceptor tray is made and erected from a die-cut blank.

11. The kit in accordance with claim 1, wherein said susceptor tray is made by pressing same from sheet material and wherein corners of said tray each have a relief feature.

12. The kit in accordance with claim 11, wherein said susceptor tray includes a raised boss to form a cradle for the food product, and wherein a gap is provided at corners of the raised boss to thereby provide the relief feature.

13. The kit in accordance with claim 1, wherein a plurality of wide-dimensioned openings and a plurality of narrow-dimensioned openings are included, said wide-dimensioned openings comprise between about 1.3 square cm and about 3.9 square cm per approximately 320 square cm of susceptor surface area, and said narrow-dimensioned openings comprise between about 29 linear cm and about 46 linear cm per approximately 320 square cm of susceptor surface area.

14. The kit in accordance with claim 1, wherein said openings comprise approximately from about 0.4 percent to about 1.6 percent of the susceptor surface area.

15. The kit in accordance with claim 1, wherein said extending portion of the susceptor tray includes a sidewall which downwardly depends with respect to said generally planar portion when said kit is in said cooking mode, and said susceptor tray is thereby adapted to elevate the dough-containing food product above the microwave oven floor and collect heated vapors during the cooking mode.

16. The kit in accordance with claim 15, wherein said extending portion sidewall is wider on the open end of the tray than on the closed end of the tray, thereby facilitating nesting of one said tray into another.

17. The kit in accordance with claim 15, wherein said extending portion sidewall is substantially imperforate and adapted to substantially retard heated vapor escape from the tray volume location.

18. The kit in accordance with claim 15, further including apertures in said extending portion sidewall in order to provide a porous sidewall adapted to permit outflow of heated vapor from the tray volume location.

19. The kit in accordance with claim 18, wherein said one or more apertures comprise between about 5 and about 30 percent of the extending portion.

20. The kit in accordance with claim 18, further including at least one aperture portion defined by perforations to facilitate transforming said aperture portion into one of said apertures.

21. The kit in accordance with claim 1, further including a raised boss at the polygonal-shaped perimeter of said generally planar portion, said raised boss being sized and shaped to accommodate the polygonal-shaped dough-containing food product during the cooking mode without having the food product substantially overlap the raised boss.

22. The kit in accordance with claim 1, wherein said dough-containing food product is a pizza having a crust portion with a polygonal-shaped perimeter in engagement with said susceptor surface during the cooking mode, the pizza having a topping over the crust member.

23. The kit in accordance with claim 1, further including a secondary packaging member which secures said dough-containing food product within said tray volume location of the susceptor tray during the packaged, pre-cooking mode.

24. A packaged microwave pizza kit, comprising:
a susceptor tray, said tray having a generally planar portion with a polygonal-shaped perimeter, an inwardly facing face and an outwardly facing face;
a susceptor surface on said outwardly facing face of the susceptor tray;
openings through said generally planar portion of the susceptor tray, said openings including at least one relatively wide-dimensioned opening from which material of susceptor tray and surface had been removed and at least one narrow-dimensioned opening;
an extending portion of said susceptor tray which projects generally away from said inwardly facing face and in a direction generally opposite to the direction that the susceptor surface faces;
said extending portion and said inwardly facing face generally define a tray volume location;
a dough-containing food product adapted to reside within said tray volume location during a packaged, pre-cooking mode of the kit, said dough-containing food product being further adapted to rest upon said outwardly facing face having said susceptor surface during a cooking mode which includes heating of the dough-containing food product by a microwave oven; and said openings are adapted to facilitate passage of heat-generating byproduct including vapor from the dough-containing food product.

25. A microwaveable dough-containing food product kit comprising:
a dough-containing food product having a crust member with a polygonal-shaped perimeter and which is at least partially baked and has edible materials supported by the crust member;
a susceptor tray having a polygonal-shaped susceptor surface and an extending portion which projects away from and in a direction opposite to the direction that the susceptor surface faces, said extending portion being sized and shaped to elevate the crust member and define a volume below the susceptor surface;
said susceptor surface has openings which permit heated vapor from the food product to pass into the open volume of the susceptor tray;
openings through said generally planar portion of the susceptor tray, said openings including at least one relatively wide-dimensioned opening from which material of susceptor tray and surface had been removed and at least one narrow-dimensioned opening; and
said extending portion and said open volume of the susceptor tray and said susceptor surface and its openings combine to provide said heated vapor in response to the application of microwave energy to the dough-containing food product, whereby enhanced heating of the crust member is effected.

26. The microwaveable kit in accordance with claim 25, wherein said polygonal-shaped susceptor surface has a plurality of corner areas, a central area and an intermediate area, and wherein a plurality of said narrow-dimensioned openings are within said intermediate area, and wherein each corner area includes at least one of said wide-dimensioned openings.

27. The microwaveable kit in accordance with claim 26, wherein said intermediate area has no wide-dimensioned opening, and wherein said narrow-dimensioned openings are slits.

28. The microwaveable kit in accordance with claim 27, wherein a plurality of slits are included and are selected from straight-line slits, curved slits, intersecting slits and pin hole slits.

29. The microwaveable kit in accordance with claim 25, wherein a plurality of wide-dimensioned openings and a plurality of narrow-dimensioned openings are included, said wide-dimensioned openings comprise between about 1.3 square cm and about 3.9 square cm per approximately 320 square cm of susceptor surface area, and said narrow-dimensioned openings comprise between about 29 linear cm and about 46 linear cm per approximately 320 square cm of susceptor surface area.

30. The microwaveable kit in accordance with claim 25, wherein said food product is a frozen pizza.

31. The microwaveable kit in accordance with claim 25, wherein said extending portion is substantially imperforate and adapted to substantially retard vapor escape from the tray volume location.

32. The microwaveable kit in accordance with claim 25, further including a secondary packaging member which secures said dough-containing food product within said tray volume location of the susceptor tray during a packaged, pre-cooking mode of the kit.

33. A polygonal susceptor tray, comprising:
a generally planar portion having a polygonal-shaped perimeter, an inwardly facing face and an outwardly facing face;
a polygonal-shaped susceptor surface at said outwardly facing face of the susceptor tray;
openings through said generally planar portion of the susceptor tray, said openings including at least one relatively wide-dimensioned opening from which material of susceptor tray and surface had been removed and at least one narrow-dimensioned opening;
an extending sidewall which projects away from and in a direction opposite to the direction that the susceptor surface faces, said extending portion being sized and shaped to maintain said susceptor surface as an elevated platform and to provide an open volume defined by the generally planar portion and the extending sidewall;
said susceptor tray being adapted to accommodate a dough-containing product having a polygonal-shaped perimeter within said open volume during a storage mode of the susceptor tray; and
said susceptor tray being adapted to provide a cooking surface for the dough-containing product resting upon said susceptor surface during a cooking mode which includes exposure of the susceptor tray to microwave energy.

34. The susceptor tray in accordance with claim 33, wherein said polygonal-shaped susceptor surface has a plurality of corner areas and each corner area includes at least one of said wide-dimensioned openings.

35. The susceptor tray in accordance with claim 33, wherein said polygonal-shaped susceptor surface has a plurality of corner areas, a central area and an intermediate area, and wherein a plurality of said narrow-dimensioned openings are within said intermediate area.

36. The susceptor tray in accordance with claim 33, wherein said polygonal-shaped susceptor surface has a plurality of corner areas, a central area and an intermediate area, and wherein a plurality of said narrow-dimensioned openings are within said intermediate area, and wherein each corner area includes at least one of said wide-dimensioned openings.

37. The susceptor tray in accordance with claim 36, wherein said intermediate area has no wide-dimensioned opening, and wherein said narrow-dimensioned openings are slits.

38. The susceptor tray in accordance with claim 37, wherein said slits are spaced from each other both longitudinally and laterally.

38. The susceptor tray in accordance with claim 37, wherein a plurality of slits are included and are selected from straight-line slits, curved slits, intersecting slits and pin hole slits.

40. The susceptor tray in accordance with claim 33, wherein said susceptor tray is made and erected from a die-cut blank.

41. The susceptor tray in accordance with claim 33, wherein said susceptor tray is made by pressing same from sheet material.

42. The susceptor tray in accordance with claim 33, wherein a plurality of wide-dimensioned openings and a plurality of narrow-dimensioned openings are included, said wide-dimensioned openings comprise between about 1.3 square cm and about 3.9 square cm per approximately 320 square cm of susceptor surface area, and said narrow-dimensioned openings comprise between about 29 linear cm and about 46 linear cm per 320 square cm of susceptor surface area.

43. The susceptor tray in accordance with claim 33, wherein said extending portion sidewall is substantially imperforate and adapted to substantially retard heated vapor escape from the tray volume location.

44. The susceptor tray in accordance with claim 33, further including a raised boss at the polygonal-shaped perimeter of said generally planar portion, said raised boss being sized and shaped to accommodate the polygonal-shaped dough-containing food product during the cooking mode without having the food product overlap the raised boss.
